(19) United States
(12) Patent Application Publication
(10) Pub. No.: US 2010/0288828 A1
(43) Pub. Date: Nov. 18, 2010

(54) ACCESSIBLE USER INTERFACE FOR ELECTRONIC DEVICES

(76) Inventors: Aisaku Pradhan, Beaverton, OR (US); Bryn Mikel McPheeters, Fort Collins, CO (US); David Lyle Nelson, Altoona, WI (US); Leslie Michele Velez, Midvale, UT (US); Thomas Brian Michon, Irvine, CA (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/466,047

(22) Filed: May 14, 2009

(51) Int. Cl. G06F 17/00

(52) U.S. Cl. 235/375

(57) ABSTRACT

A method for performing an action at an electronic device. The method includes extracting data from a token. The data includes at least one command instruction or command attribute. The method includes interpreting the data and executing an action corresponding to the command instruction or the command attribute.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to office product devices, and more particularly to methods for controlling those devices.

2. Description of the Related Art

In the prior art, interactions with office product devices, such as printers, copiers, scanners, facsimile machines or multifunction devices having the capability to print, copy, scan and/or fax, are accomplished through a device user interface. Such device interface may take many different forms. A user interface can simply be one or more buttons with fixed or static labels. A user interface may also be a touch screen display or a display screen associated with one or more input devices such as a keyboard or mouse.

While these user interfaces offer flexibility to most users by allowing a user to rearrange, reprogram or modify the functions associated with the labels and buttons and/or increase the number buttons on the display screen for additional functionality, these interfaces may still present challenges to users with visual and/or physical impairments. For example, with touch screen display screens, users having limited vision or lacking fine motor control may be unable to locate and/or press virtual buttons reliably.

In order to make the interaction between the user and office product devices more effective, such devices may have multiple forms of interaction and user interfaces available such as a numeric touch pad of hard buttons as well as a touch screen display. However, additional input methods to the user interface do not necessarily solve the problem, as there may still be some groups of users for whom any given set of methods of interaction is unsuitable. Further, additional input capabilities may increase the cost of the office product device, and confusion may result from duplicate modes of interaction. Thus, an alternate paradigm of interaction is needed since no single method of interaction is likely suitable for all users.

### SUMMARY OF THE INVENTION

In light of above, there is a need for a method and system improving interactions between users with disabilities and electronic devices through accessible user interfaces.

The present invention provides a method for performing an action at an electronic device. The method includes extracting data from a token. The data includes at least one command instruction or command attribute. The method includes interpreting the data and executing an action corresponding to the command instruction or the command attribute. The method may also recognize the token.

Various technologies for extracting the data from the token may be used. In some embodiments, optical character recognition technology utilized. In other embodiments, optical mark recognition may be used. In yet other embodiments, a radio frequency identification (RFID) tag reader may also be used. In still other embodiments a barcode reader or magnetic card reader may be used. The data also may be extracted from the token via a scanner. The data may also be extracted via a wireless connection.

Interpreting the data may include extra comparing the extracted command instruction to entries in a database. Interpreting the data may include extra comparing the extracted command attribute to entries in a database.

The method may also include creating the token. Creating a token may include receiving at least one command instruction or at least one command attribute from a user. Creating a token may occur at the device. Creating a token may occur remotely.

The method may also include returning the setting of the device to a default setting. The method may also include providing voice confirmation of the extracted data to a user.

The present invention also provides an apparatus for performing the above-described method. The apparatus includes an input means for receiving data from a token, wherein the data includes at least one of a command instruction and a command attribute and a processing means for interpreting the received data and for executing an action corresponding to the command instruction or the command attribute. The apparatus may also include a communication mechanism for providing voice confirmation of the data received to a user.

The present invention also provides a computer-readable storage medium with instructions for extracting data from a token, wherein the data includes at least one command instruction or command attribute; interpreting the data; and executing an action at an electronic device corresponding to the at least one of the command instruction and the command attribute.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of a first embodiment of a device 100 which executes one or more commands contained on one or more command tokens;

FIG. 2 illustrates various implementations of a command token employing barcode technology.

FIG. 3 illustrates a process in which a command token is used to carry out actions on the device of FIG. 1.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware.

The present invention relates to command tokens which may be used to control the actions of an electronic device, such as an office product device. Essentially, the command token contains machine-readable or machine-recognizable data that may be used in performing actions on the office product device. Thus, the command token may contain control or command data used to perform the desired actions on the office product device. The command token may also contain attribute data relating to features or attribute settings associated with a device action for a particular job or user.

In the context of office product devices, command data may be commands that carry out office product device functions, such as print, copy, scan and/or fax. Examples of attribute data may include, but are not limited to, stapling, collating, color or black and white, duplex, e-mail addresses and facsimile numbers. As will be appreciated by one of ordinary skill in the art, attribute data may be associated with more than one device function. For example, color or black and white may be associated with the print, copy, scan and/or fax functions and duplex may be associated with printing and scanning.

The command token may contain only command data for a single function, such as scan or copy, or multiple functions such as copy and e-mail. In an alternate embodiment, the command token may contain only attribute data for an individual feature or attribute that may be used for a particular job, such as color, black and white, or duplex, or it may contain attribute data for multiple features or attributes that may be used together for a particular job, such as color and duplex.

In yet other embodiments, the command token may contain both command data and attribute data for a particular function. For example, a user desiring to minimize the use of paper printed may have a command token that contains attribute data for four-up and duplex and command data to print. In an alternate embodiment, the command token may contain attribute data for complementary features or attributes such as four-up and duplex.

Command tokens may take any form or be made out of any object desired by a user, provided the command token is recognizable by the device for which it is designed or has a suitable communication mechanism embedded, attached or otherwise affixed to it. Command tokens may also employ multiple means of recognition. For example, a command token may be a sheet of paper or other media containing a barcode, an RFID tag, fiducial mark or other predesignated symbol that indicates command and/or attribute data. Command tokens may also use electronic communications means, such as Bluetooth or Wi-Fi to establish communication between the command token and the device. In some forms, command tokens may also use magnetic stripe or proximity card technology.

Additionally or alternately, command tokens may also use sound as a communication mechanism to provide command data to the device or confirmation of the command data and/or attribute data to a user. For example, the technology used in greeting cards which, when opened, playback a prerecorded audio message or allow the recording of a voice message may be incorporated into a command token. Command tokens containing such an inexpensive audio reproduction means may allow a user to hear a description of the command data or attribute data contained on the command token.

Command tokens may also be color-coded. For example, a user who desires to minimize the use of paper may want as a mnemonic a green-colored command token that represents an environmentally friendly mode.

Command tokens may also be configurable from job to job. Some commands given to a device may contain parameters that change depending upon the job. Such parameters include, but are not limited to, the number of copies, the destination fax number(s) and the destination e-mail address(es). One method to accomplish the receipt of variable input would be to create one command token for each potential input. Thus, if a user desired to make ten copies of a document, the user could assemble the command tokens in a manner that presents them in the sequence of 1 followed by a 0. Alternately, a command token for making copies could have a blank that the user completes to request the desired number of copies. Still yet another command token which allows for variable inputs would be a command token containing dials that allow the user to set the desired input. For example, a command token for making copies may include rotatable dials for allowing the user to set the dials to the number of copies desired.

Command tokens may also take the form of a flat menu system. On many devices, where there are numerous menu options available to a user, such options are typically presented in a hierarchical menu system due to limitations of the built-in user interface on the device. Using such a hierarchical menu system may require a user to scroll through different parts of the menu to find a desired option, select it then navigate to the next desired option. With command tokens, it may be possible to display all of the options available to the user at once. The user could then quickly go directly to the desired options and select them on the command token without having to scroll up and down several menus.

One way of creating a non-hierarchical or flat menu command token would be to present the available options on a pre-printed form. Various categories of options may be color-coded in order to make them more readily identifiable. Such command tokens may be valuable to impaired users who repeatedly carry out the same functions on a device, and they can speed up the user's ability to traverse the menu of available options and verify at a glance that the options selected are complete and correct.

Command tokens may also be used with other assistive technologies. For example, the Lexmark Accessibility Solution marketed by Lexmark International, Inc. allows a user to interact with a multi-function peripheral (“MFP”) from a workstation. The user assembles the commands he wishes to carry out, and these commands are stored on the MFP as a shortcut identified as a shortcut number, such as “#3”. With the Lexmark Accessibility Solution, the user then goes to the MFP to execute that shortcut, and the user must enter the shortcut number on the numeric keypad. The number pad is much more accessible than the touch screen, but this could still be difficult for users who are visually impaired or who lack fine motor control. With this type of command token, the command data is the command to execute a previously stored shortcut rather than a particular device function. This provides the user the flexibility of utilizing an alternate input mechanism to control the device instead of the input mechanism provided by the manufacturer.

While the present invention is described as controlling actions on an office product device, it will be appreciated by one of ordinary skill in the art, that the methods described herein may be applied to any electronic device.

The creation and use of the command tokens will now be described in connection with an exemplary office product device.

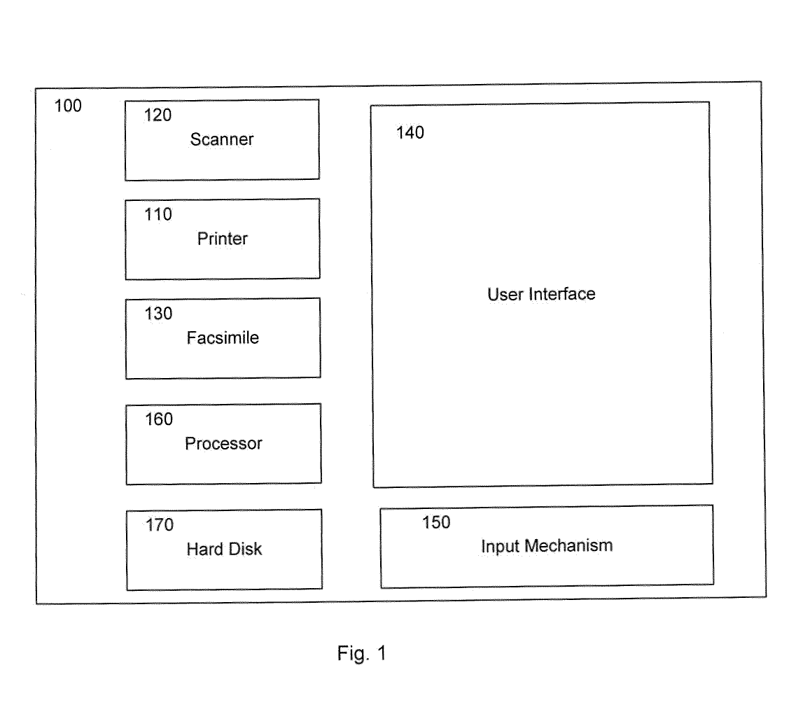

FIG. 1 is a block diagram of a first embodiment of a device 100 which executes one or more commands contained on one or more command tokens. One exemplary device which may recognize command tokens is an x646e MFP marketed by Lexmark International, Inc. This device provides an Embedded Solutions Framework (ESF). The ESF provides the ability to download and execute software applications on the MFP, such as launching and controlling workflows. Workflows include, but are not limited to copy jobs, scan jobs, print jobs and facsimile jobs.

Device 100 may have a printer component 110, scanner component 120 and/or facsimile component 130 for performing the functions of printing, copying, scanning and/or faxing. In an alternate embodiment, device 100 may be a single function device such as a printer, copier, scanner or facsimile machine.

Device 100 may include a user interface 140, such as a graphical user interface, a character display, or any other output mechanism for communicating information to a user. Device 100 may also include an input mechanism 150 for receiving user commands and/or device 100 or job feature selections. Input mechanism 150 may include one or more user selectable buttons, a keyboard, a mouse or any other component for receiving user inputs. In an alternate embodiment, the user interface and input mechanism may be a single component, such as a touch screen display.

Device 100 may also include a processor 160 for executing instructions which interpret command data or user inputs and execute or carry out an action corresponding to the command data. Such instructions may be contained in firmware, a software application or plug-in.

Device 100 may also include a hard disk 170 for storing instructions and data.

Device 100 must also have the appropriate technology or communication means to interpret command tokens. Such technology or communication means may be integrated into device 100 or may be external components attached to device 100 via a communications port, such as a USB port. For example, device 100 must include the appropriate firmware, software and/or hardware to interpret barcode or RFID technology if the command token utilizes a barcode or RFID tag as the communication means. In embodiments where the command token comprises a character, fiducial mark or other predesignated symbol, device 100 must include optical character recognition (OCR), optical mark recognition (OMR) technology, intelligent character recognition (ICR) and/or shape recognition technology, as appropriate, implemented in firmware, software and/or hardware. In other embodiments where command tokens are implemented using known wireless communication protocols, such as Bluetooth or Wi-Fi, device 100 also includes an antenna for transmitting and/or receiving data. In still other embodiments where the command tokens are sound based, device 100 also includes speech recognition technology for receiving and transmitting sound.

Command tokens for use in connection with device 100 may be created using a variety of methods, depending upon the communication means desired. For example, where the command tokens employ optical character or optical mark recognition, the command data and attribute data may be created using known word processing or imaging software and printed on a piece of paper, transparency or other media.

For command tokens using barcode technology, command data and attribute data may be encoded into a barcode label generated from barcode creation software. The barcode may then be printed and if desired, attached to a wide range of objects.

RFID-based command tokens are created using any RFID programming device to program the RFID tag. The tag, if not already embedded in a suitable object, may then be attached to any object thereby resulting in the object becoming the command token. One exemplary device that could program an RFID tag with command data to control and produce output desired by a user is the Lexmark T640RN laser printer manufactured by Lexmark International, Inc. Such device is also capable of printing the image or text description associated with the command for recognition by the user.

Wireless communications-based command tokens utilizing technologies such as Bluetooth, Wi-Fi or wireless USB, may be created. Command tokens implementing sound may be created using speech recording technology. Other examples of communication between the command token and the device would include USB, TCP/IP.

As will be appreciated by one of ordinary skill in the art, the creation of command tokens may take place at a host computing device or any other device having the requisite hardware, software and/or firmware. The creation of command tokens may also occur at device 100 utilizing an ESF application designed to create command tokens or on any other device typically used for implementing the communication means desired by user for the command token.

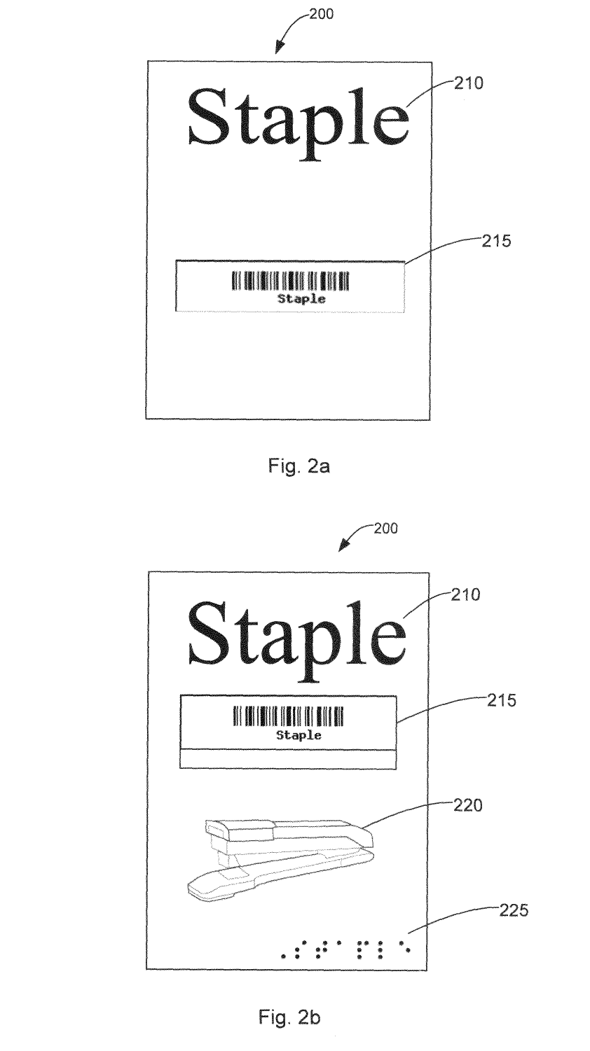

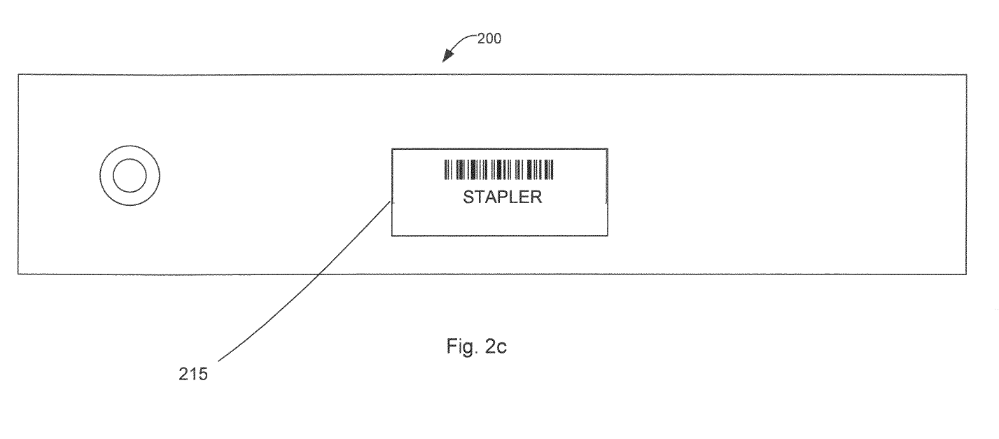

FIGS. 2a-2c illustrate one embodiment of a command token employing barcode technology. In this first embodiment, the barcode may be printed on media such as a transparency or sheet of paper. FIG. 2a illustrates a command token 200 containing a printed description of the command 210 (i.e., “Staple”) and a barcode 215 encoded with the attribute data for directing device 100 to perform a staple function. FIG. 2b is another embodiment of FIG. 2a, wherein a picture of the command 220 and a Braille description 225 have been added. FIG. 2c illustrates yet another embodiment of command token 200, wherein the barcode 215 has been affixed to a stapler. A command token can be made out of any object the user desires by simply attaching a suitable communication mechanism. As will be appreciated by one of ordinary skill in the art, the command token 200 may be printed with some or all of the information described in FIGS. 2a-2c, or it may even contain different or additional information.

Command tokens can also present a user with selectable commands. For example, a preprinted sheet may list any or all possible commands and attributes available with the device. The commands or attributes to be performed are selected by the user by making an appropriate mark or by filling in an appropriate blank. Options that are desired could be selected with the check. For those options requiring parameters the user could have the parameter values written in. The user would scan an image of the flat menu and OMR software within the device would identify options that have been selected and ICR software would read any handwritten parameter values.

Once the command token has been created, it can then be used to control device 100. In order to function properly, the device must have a way of determining what actions to perform in response to the command data received from the command token. In one embodiment, the device employs a command action database created using a text editor and stored on a hard disk of the device. This database contains records which include a search field and one or more command action designators. For example, one record may contain the text “GREEN 4UP DUPLEX.” GREEN is the search field while 4UP DUPLEX are command action designators. When presented with a command token, the device may receive the command data “GREEN COPY.” That command data is parsed to identify individual character strings. First the string GREEN is compared to the search fields in the database to retrieve the corresponding record. The one or more command action designators in that record indicate what parameters should be set or actions should be performed. Next the string COPY is processed. In this example, in response to the command data GREEN COPY, a copy job will be executed producing output that is printed 4up and duplex.

It is also possible to indicate that parameter values are needed. For example, a command action database entry may contain the text “GREEN #UP DUPLEX COPIES #.” The character # is an indication that character substitution needs to be performed in order to supply a parameter value. In this case, the command data would need to contain both the search field and any needed parameter values. If the command data received is “GREEN 2 10 COPY” then when the command action record for GREEN is retrieved and parsed the character 2 will be substituted for the first occurrence of the character # and the characters 10 will be substituted for the second occurrence of the character #. The device will execute a copy job producing 10 copies that are 2up and duplex.

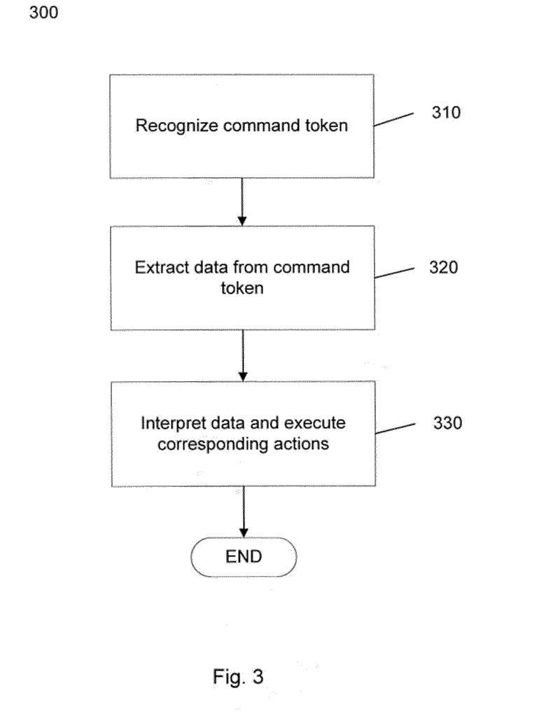

FIG. 3 illustrates a process 300 in which a command token is used to carry out actions on device 100 of FIG. 1.

At block 310, the command token is recognized by device 100. In some embodiments, the recognition of a command token may occur only after a user provides an indication that a command token is present. For example, when the command token uses a scanner as a communication means, such as in the case of a barcode, fiducial mark, or predesignated symbol, a user may make a particular selection (e.g., pressing a designated key on a keypad, touching screen display in a preset location, inputting a designated sequence using input mechanism 150, etc.) in order to differentiate or distinguish to device 100 that the document or item to be scanned is a command token and not simply a job. Such selection may also indicate to device 100 to initiate the appropriate application or component to read the command token. In one implementation, such application may be a standard barcode, optical character or mark recognition program. In another implementation, such application may be a customized command token application which may monitor device 100 for a button press or screen touch and when detected, initiates a workflow to control device 100 based upon the command data and attribute data contained on the command token.

In other embodiments, recognition of a command token may occur automatically as the user approaches device 100, such as in the case of a RFID-based or wireless communications-based command token.

Once device 100 recognizes the command token, command data and attribute data may be extracted from the command token.

At block 320, processor 160 extracts the command data and attribute data from the command token. The methods for extracting command data and attribute data depend upon the communication means between the command token and device 100.

In one embodiment, an application may monitor device 100 for a button press or screen touch and when detected, the application initiates a workflow that captures a scanned image of the command token using scanner component 120. The captured image may then be searched to detect whether a barcode, is present. If a barcode is found, the application decodes the barcode using a barcode interpreter.

In another embodiment where the command tokens are configurable and/or utilize characters, fiducial marks or other predesignated symbols, OCR, OMR and/or ICR technology may be used to extract the command data and attribute data from the command token. As will be appreciated by one of ordinary skill in the art, such barcode interpreter, OCR, OMR and ICR technology may be implemented as hardware firmware, software or any combination thereof within the device. Such barcode interpreter, OCR, OMR and ICR technology may also be part of an application, such as an ESF application, specifically designed to control device 100 using command tokens.

In embodiments employing dials, command data and attribute data may be extracted from the command token using an electronic communication means such as Bluetooth or Wi-Fi.

In embodiments employing RFID tags, an RFID tag reader extracts the command data and attribute data from the command token. In one implementation, an ESF application monitors the USB host port where an RFID reader has been connected and extracts command data and attribute data as it is received.

At block 330, the extracted data is interpreted, and the corresponding actions are executed. In one embodiment, an ESF application compares the extracted data to a database of command actions. These actions may be to set job parameters, such as duplex output, and/or initiate a workflow, such as a copy job. The database entries may also be customized to allow a single command token to be associated with any set of actions permitted by device 100. In some embodiments, command instructions may be housed in a separate database from command attributes.

The extracted data are used as search field entries in a database of command actions. The matching database entry that is returned by the search contains a set of one or more actions that the application then instructs device 100 to execute or carry out. If no database entry matches the extracted data, device 100 may not perform any action. In such instances, device 100 may generate and communicate an error message to the user. Such communication may occur visually or verbally.

In some embodiments, where multiple commands and/or attributes are extracted, device 100 may perform only those actions that have a matching database entry and ignore the remaining commands and/or instructions.

The actions may be automatically executed by device 100 or require user intervention. For example, in some embodiments the entire command set to carry out an action may be contained on a single command token. In other embodiments, multiple command tokens may be interpreted together to perform the desired actions automatically.

In yet other embodiments where device 100 is equipped with a voice synthesizing mechanism, the description of the description of the command data or attribute data contained on the command token may be read to a user for confirmation that the user selected the desired command token. In still other embodiments, where the desired action requires a configurable parameter, such as e-mail address or destination facsimile number, device 100 may wait for additional input from the user.

Once the corresponding actions are executed, the settings of device 100 are returned to their previous or default state.

In the case of the tokens being sheets of paper, the user could assemble the stack of command tokens and have them presented to the MFP prior to the job that is to be processed. In another embodiment the command tokens are sheets of transparent media.

Identification of a command token by the device is performed by software designed to receive command data from a token and then to carry out a corresponding action. Identifying a token and receiving the command data can be performed by having the software capture the signals from an RFID reader attached to the device. Any data received from the

RFID reader is understood to be command data. Once received, an associated set of one or more actions is carried out. In some embodiments the identification of command tokens is more complicated. For example using the scanner of an MFP to scan both command tokens and the pages of a job to copied means that the device software must be able to distinguish between scans of command tokens and scans of pages to be copied. Identifying a command token can take the form of scanning an image and searching for a barcode, fiducial mark or other predesignated symbol that indicates that the object being scanned is a command token. If a predesignated symbol such as a barcode is found, software is able to decode it thereby receiving the command data. The device software will continue to identify tokens and receive the command data as long as each new image contains a pre-designated symbol that identifies it as representing a command token. If no command token is identified in an image, then the image is understood to be the initial page of a user job.

The foregoing description of several methods and embodiments of the present invention has been presented for purposes of illustration. It is not intended to be exhaustive or to limit the present invention to the precise actions and/or forms disclosed, and obviously many modifications and variations are possible in light of the above teaching. It is intended that the scope of the invention be defined by the claims appended hereto.

What is claimed is:

1. A method for performing an action at an electronic device, comprising:
extracting data from a token, wherein the data includes at least one of a command instruction and a command attribute;
interpreting the data; and
executing an action corresponding to the at least one of the command instruction and the command attribute.

2. The method of claim 1, further comprising recognizing the token.

3. The method of claim 1, wherein optical character recognition technology is used in the extracting the data from the token.

4. The method of claim 1, wherein optical mark recognition technology is used in the extracting the data from the token.

5. The method of claim 1, wherein an RFID tag reader is used in the extracting the data from the token.

6. The method of claim 1, wherein a barcode reader used in the extracting the data from the token.

7. The method of claim 1, wherein a magnetic card reader is used in the extracting the data from the token.

8. The method of claim 1, wherein the data from the token is extracted via a scanner.

9. The method of claim 1, wherein the data from the token is extracted via a wireless connection.

10. The method of claim 1, wherein the interpreting the data comprises comparing the extracted command instruction to entries in a database of command actions.

11. The method of claim 1, wherein the interpreting the data comprises comparing the extracted command attribute to entries in a database of attributes.

12. The method of claim 1, further comprising creating the token.

13. The method of claim 12, wherein the creating the token includes receiving at least one of a command instruction and a command attribute from a user.

14. The method of claim 12, wherein the creating the token is performed at the device.

15. The method of claim 12, wherein the creating the token is performed remotely.

16. The method of claim 1, further comprising returning a setting of the device to a default setting.

17. The method of claim 1, further comprising providing voice confirmation of the extracted data to a user.

18. An apparatus, comprising:
an input means for receiving data from a token, wherein the data includes at least one of a command instruction and a command attribute; and
a processing means for interpreting the received data and for executing an action corresponding to the at least one of the command instruction and the command attribute.

19. The apparatus of claim 17, further comprising a communication mechanism for providing voice confirmation of the received data to a user.

20. A computer-readable storage medium, comprising instructions for:
extracting data from a token, wherein the data includes at least one of a command instruction and a command attribute;
interpreting the data; and
executing an action at an electronic device corresponding to the at least one of the command instruction and the command attribute.
